(19) United States
(12) Patent Application Publication
(10) Pub. No.: US 2007/0127103 A1
(43) Pub. Date: Jun. 7, 2007

(54) Powder and particle processing apparatus and baffle device

(76) Inventors: Kazuomi Unosawa, Shinjuku-ku (JP); Kuniaki Yamanaka, Shinjuku-ku (JP); Shigemi Isobe, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/633,024

(22) Filed: Dec. 4, 2006

(30) Foreign Application Priority Data
Dec. 5, 2005 (JP) 2005-350606

(51) Int. Cl. G02B 26/08

(52) U.S. Cl. 359/196

(57) ABSTRACT

A powder and particle processing apparatus comprising multifunctional baffle devices is capable of not only mixing and stirring powders and particles but also ventilating and cooling a processing container by itself. The boot-shaped baffle devices 22 are arranged in the granulation/coating apparatus 1 having a rotary drum 2. Each of the baffle devices 22 has a hollow baffle main body 24 provided with ventilating holes 32, a ventilating pipe 35 held in communication with the internal space 31 of the body 24, cooling tubes 34 arranged at the body 24 so as to allow a cooling medium 33 to flow through them and a cooling medium supply/discharge pipe 36 held in communication with the tubes 34. The baffle devices 22 are adapted to mix/stir the powders and particles in the drum 2, exhaust air from the body 24 by way of the holes 34 and the pipes 35 and cool the body 24 by means of the tubes 32 and the pipes 36. As a result, the baffle devices 22 can provide the three functions of mixing/stirring, ventilation and cooling.

### BACKGROUND OF THE INVENTION

1. Field of the Invention

This invention relates to a powder and particle processing apparatus for containing powders and particles in a rotary drum and performing a granulating/coating operation on the powders and particles. More particularly, the present invention relates to a powder and particle processing apparatus equipped with a multifunction baffle device capable of not only mixing and stirring the powders and particles but also ventilating and adjusting the temperature of the processing container of the processing apparatus by itself.

2. Related Statement Art

Granulation/coating apparatus employing a rotary drum (powder and particle processing apparatus) are known as apparatus for manufacturing medicines and foods. For example, Japanese Patent Publication No. 3129786 describes an apparatus for driving a rotary drum having a polygonal (octagonal in the description) cross section to rotate around a horizontal axial line. Such a rotary drum is also referred to as coating pan and provided in the inside with a sprayer for supplying coating liquid. Powders and particles are put into the rotary drum and driven to roll with the drum and coating liquid is sprayed onto the surfaces thereof from the sprayer. At this time, hot air and cool air are appropriately supplied into and exhausted from the rotary drum in order to accelerate the process of forming the coating layers and also the drying process. A baffle that can be driven to rotate is arranged in the inside of the rotary drum. The baffle is adapted to move into the powders and particles from a central area of the rotary drum so as to agitate the rolling flow of the powders and particles to raise the mixing/stirring efficiency.

Jpn. Pat. Appln. Laid-Open Publication No. 50-30153 discloses a granulation/coating apparatus provided with a device for supplying air into and exhausting air from a rotary drum. An air supply/exhaust duct having a dual pipe structure is inserted and held in the rotary drum and a boat-like air supply/exhaust section is formed at the front end thereof. The air supply/exhaust section is inserted into the layer of powders and particles in the rotary drum to draw out the air that has been supplied into the rotary drum and passed through the layer and dispel it to the outside of the apparatus. A baffle (baffle board) is arranged on the wall surface of the rotary drum to accelerate the operation of mixing/stirring the powders and particles.

Jpn. Pat. Appln. Laid-Open Publication No. 9-66227 also discloses a granulation/coating apparatus equipped with an exhaust means to be inserted into the layer of powders and particles in the inside. In this apparatus, an air supply pipe is connected to an end aperture section of the rotary drum and air is supplied from the air supply pipe into the rotary drum. An air collecting member having a hollow main body is arranged in the rotary drum and air is drawn in through a hole formed at an end of the hollow main body. The hollow main body is employed with a baffle (deflector board) to draw out air from the layer of powders and particles (object). In both the apparatus of Jpn. Pat. Appln. Laid-Open Publication No. 50-30153 and that of Jpn. Pat. Appln. Laid-Open Publication No. 9-66227, while the air supply/exhaust section is inserted into the layer of the powders and particles and hence may be assumed to function as a baffle, a baffle is also provided and the hollow main body is used exclusively as air flow path.

Meanwhile, with any of the above listed granulation/coating apparatus, the coating liquid adhering to the inner wall of the rotary drum and the baffle eventually falls to form small particles, which then adhere to the product in the rotary drum to turn it into a defective product. For this reason, the rotary drum and the baffle have to be appropriately cooled in order to prevent the temperature of the rotary drum from unnecessarily rising during the coating process. Jpn. Pat. Appln. Laid-Open Publication No. 1-315329 discloses a coating apparatus in which a cooling pipe is arranged in the baffle thereof. In this apparatus, the temperature of cooling water being supplied to the cooling pipe is appropriately controlled according to the information from a temperature sensing element. Cool air is supplied from an air conditioner to the outside of the rotary drum. The air conditioner cooperates with the cooling pipe to lower the temperature of the rotary drum and that of the baffle in order to prevent coating liquid from adhering to them. However, there may be cases where the rotary drum and the baffle are preferably appropriately heated when the apparatus is operated for chocolate coating.

As pointed out above, the three functions of mixing/stirring, ventilation and temperature adjustment (cooling, heating) are essential for the treatment process in a granulation/coating apparatus. Therefore, for instance, the apparatus disclosed in Jpn. Pat. Appln. Laid-Open Publication No. 1-315329 is provided with a baffle having a temperature adjusting means and a blower is additionally provided to ventilate the drum. However, while the granulation/coating apparatus disclosed in Jpn. Pat. Appln. Laid-Open Publication No. 1-315329 is provided with the function of mixing/stirring and that of temperature adjustment and those disclosed in Jpn. Pat. Appln. Laid-Open Nos. 50-30153 and 9-66227 are provided with the function of mixing/stirring and that of ventilation, no known apparatus is provided with both the function of temperature adjustment and that of ventilation. Furthermore, there exists no granulation/coating apparatus that is provided with the three essential functions of mixing/stirring, ventilation and temperature adjustment. In other words, known granulation/coating apparatus are provided only with one or two of the three essential functions that are realized by using additional parts. Thus, the inside of the granulation/coating apparatus is made to show a complex arrangement to raise the number of components of the apparatus and hence the manufacturing cost. Additionally, such an apparatus is inevitably dimensionally large.

### SUMMARY OF THE INVENTION

In view of the above identified problems, it is therefore the object of the present invention to provide a multifunctional baffle device capable of not only mixing and stirring powders and particles but also ventilating and adjusting the temperature of a processing container by itself.

According to the present invention, there is provided a powder and particle processing apparatus comprising a rotary drum adapted to rotate around an axial line and capable of containing powders and particles in the inside and a baffle device arranged in the rotary drum so as to be inserted into the powders and particles in the rotary drum, the baffle device including: a hollow main body section to be inserted into the powders and particles; ventilating holes formed in the main body section to keep the inside and the outside of the main body section in communication with the each other; a ventilating pipe fitted to the main body section and held in communication with the internal space of the main body section; a temperature adjusting section arranged at the main body section and adapted to allow a temperature adjusting medium to flow in the inside thereof; and a temperature adjusting medium supply/discharge pipe fitted at the main body section and held in communication with the temperature adjusting section.

According to the invention, a powder and particle processing apparatus having a rotary drum is provided with a baffle device that comprises a hollow main body section having ventilating holes to keep the inside and the outside of the main body section in communication with each other, ventilating pipes held in communication with the internal space of the main body section, a temperature adjusting section arranged at the main body section and adapted to allow a temperature adjusting medium to flow in the inside thereof and a temperature adjusting medium supply/discharge pipe held in communication with the temperature adjusting section. Thus, the powders and particles in the rotary drum are mixed and stirred by the baffle device and air is exhausted from the main body section by way of the ventilating holes and the ventilating pipes, while the temperature of the main body section is adjusted (cooled, heated) by means of the temperature adjusting section and the temperature adjusting medium supply/discharge pipe. With this arrangement, a single baffle device can realize the three essential functions of mixing/stirring, ventilation and temperature adjustment by itself.

In a powder and particle processing apparatus according to the present invention, the temperature adjusting medium may be a cooling medium using water or air and the temperature adjusting section may be a cooling section for cooling the main body section. Alternatively, the temperature adjusting medium may be a heating medium using water or air and the temperature adjusting section may be a heating section for heating the main body section. In a powder and particle processing apparatus according to the present invention, the main body section may include a bottom surface section arranged vis-à-vis the inner wall of the rotary drum, a hollow upper section formed above the bottom surface section and an aperture section formed at the upper end of the upper section and connected to the ventilating pipe. Then, the main body section may be made to show a shoe-like profile.

In a powder and particle processing apparatus according to the present invention, the temperature adjusting medium supply/discharge pipe may include a temperature adjusting medium supply chamber for supplying the temperature adjusting medium to the temperature adjusting section and a temperature adjusting medium discharge chamber for discharging the temperature adjusting medium from the temperature adjusting section, the temperature adjusting medium supply chamber and the temperature adjusting medium discharge chamber being arranged outside the ventilating pipe. Preferably, a powder and particle processing apparatus according to the present invention further comprises a baffle supporting member inserted into the rotary drum from the outside of the latter and connected to the ventilating pipe and the temperature adjusting medium supply/discharge pipe. Then, the temperature adjusting medium supply/discharge pipe may include a temperature adjusting medium supply chamber for supplying a temperature adjusting medium to the temperature adjusting section and a temperature adjusting medium discharge chamber for discharging the temperature adjusting medium from the temperature adjusting section and the baffle supporting member may be a three-chamber structure having the ventilating pipe, the temperature adjusting medium supply chamber and the temperature adjusting medium discharge chamber.

In a powder and particle processing apparatus according to the present invention, the temperature adjusting section may be a temperature adjusting pipe laid on the surface of the main body section. In a powder and particle processing apparatus according to the present invention, the baffle device may be made movable in a direction selected from the axial direction, the direction of rotation of the rotary drum and a radial direction of the rotary drum.

According to the present invention, there is also provided a baffle device to be used in a powder and particle processing apparatus having a rotary drum, the device comprising: a hollow main body section; ventilating holes formed in the main body section to keep the inside and the outside of the main body section in communication with each other; a ventilating pipe fitted to the main body section and held in communication with the internal space of the main body section; a temperature adjusting section arranged at the main body section and adapted to allow a temperature adjusting medium to flow in the inside thereof; and a temperature adjusting medium supply/discharge pipe fitted at the main body section and held in communication with the temperature adjusting section.

According to the present invention, a baffle device to be used in a powder and particle processing apparatus having a rotary drum comprises a hollow main body section having ventilating holes for keeping the inside and the outside of the main body section in communication with the each other, a ventilating pipe held in communication with the internal space of the main body section, a temperature adjusting section arranged at the main body section and adapted to allow a temperature adjusting medium to flow in the inside thereof and a temperature adjusting medium supply/discharge pipe held in communication with the temperature adjusting section, it can mix/stir the powders and particles in the rotary drum by means of the baffle device and, at the same time, exhaust air from the main body section by way of the ventilating holes and the ventilating pipe, while it can adjust the temperature of the main body section (cooled, heated) by means of the temperature adjusting section and the temperature adjusting medium supply/discharge pipe. With this arrangement, a single baffle device can realize the three essential functions of mixing/stirring, ventilation and temperature adjustment by itself.

In a baffle device according to the present invention, the temperature adjusting medium may be a cooling medium using water or air and the temperature adjusting section may be a cooling section for cooling the main body section. Alternatively, the temperature adjusting medium may be a heating medium using water or air and the temperature adjusting section may be a heating section for heating the main body section.

In a baffle device according to the present invention, the main body section may include a bottom surface section arranged vis-à-vis the inner wall of the rotary drum, a hollow upper section formed above the bottom surface section and an aperture section formed at the upper end of the upper section and connected to the ventilating pipe. Then, the main body section may be made to show a shoe-like profile.

In a baffle device according to the present invention, the temperature adjusting medium supply/discharge pipe may include a temperature adjusting medium supply chamber for supplying the temperature adjusting medium to the temperature adjusting section and a temperature adjusting medium discharge chamber for discharging the temperature adjusting medium from the temperature adjusting section, the temperature adjusting medium supply chamber and the temperature adjusting medium discharge chamber being arranged outside the ventilating pipe. Additionally, the temperature adjusting section may be a temperature adjusting pipe laid on the surface of the main body section.

Thus, as a powder and particle processing apparatus according to the present invention comprises a rotary drum and a baffle device that includes a hollow main body section having ventilating holes for keeping the inside and the outside of the main body section in communication with the each other, a ventilating pipe held in communication with the internal space of the main body section, a temperature adjusting section arranged at the main body section and adapted to allow a temperature adjusting medium to flow in the inside thereof and a temperature adjusting medium supply/discharge pipe held in communication with the temperature adjusting section, it can mix/stir the powders and particles in the rotary drum by means of the baffle device and, at the same time, exhaust air from the main body section by way of the ventilating holes and the ventilating pipe, while it can adjust the temperature of the main body section by means of the temperature adjusting section and the temperature adjusting medium supply/discharge pipe. With this arrangement, a single baffle device can realize the three essential functions of mixing/stirring, ventilation and temperature adjustment by itself, it can simplify the configuration of the powder and particle processing apparatus if compared with known powder and particle processing apparatus. Thus, the inside of the powder and particle processing apparatus is made to show a simple arrangement to reduce the number of components of the apparatus and hence the manufacturing cost. Additionally, such an apparatus can be downsized.

As a baffle device to be used in a powder and particle processing apparatus having a rotary drum according to the present invention comprises a hollow main body section having ventilating holes for keeping the inside and the outside of the main body section in communication with the each other, a ventilating pipe held in communication with the internal space of the main body section, a temperature adjusting section arranged at the main body section and adapted to allow a temperature adjusting medium to flow in the inside thereof and a temperature adjusting medium supply/discharge pipe held in communication with the temperature adjusting section, it can mix/stir the powders and particles in the rotary drum by means of the baffle device and, at the same time, exhaust air from the main body section by way of the ventilating holes and the ventilating pipe, while it can adjust the temperature of the main body section by means of the temperature adjusting section and the temperature adjusting medium supply/discharge pipe. With this arrangement, a single baffle device can realize the three essential functions of mixing/stirring, ventilation and temperature adjustment by itself, it can simplify the configuration of the powder and particle processing apparatus. Thus, the inside of the powder and particle processing apparatus is made to show a simple arrangement to reduce the number of components of the apparatus and hence the manufacturing cost. Additionally, such an apparatus can be downsized.

### BRIEF DESCRIPTION OF THE DRAWINGS

FIG. 1 is a schematic cross sectional view of the first embodiment of the present invention, which is a granulation/coating apparatus, illustrating the configuration thereof;

FIG. 2 is a schematic cross sectional view of granulation/coating apparatus of FIG. 1 as viewed in the direction of the axis of rotation of the rotary drum thereof;

FIG. 3 is a schematic perspective view of the baffle main body of the apparatus of FIG. 1, as viewed from a lateral side thereof;

FIG. 4 is a schematic perspective view of the baffle main body of the apparatus of FIG. 1, as viewed from above;

FIG. 5 is a schematic perspective view of the baffle main body of the apparatus of FIG. 1, as viewed from below;

FIG. 6 is a schematic cross sectional view of the baffle main body taken along line B-B in FIG. 4;

FIG. 7 is a schematic cross sectional view of the baffle main body taken along line A-A in FIG. 3;

FIG. 8 is a schematic illustration of the effect of the baffle main bodies in the layer of powders and particles;

FIG. 9 is a schematic cross sectional view of the second embodiment of the present invention, which is a granulation/coating apparatus, illustrating the configuration thereof;

FIG. 10 is a schematic cross sectional view of the rotary drum of the granulation/coating apparatus of FIG. 9 as viewed in the direction of the arrow C in FIG. 9; and

FIGS. 11A through 11F are schematic illustrations of modified baffle main bodies, illustrating the structures thereof.

### DETAILED DESCRIPTION OF THE PREFERRED EMBODIMENTS

Now, the present invention will be described in greater detail by referring to the accompanying drawings that illustrate preferred embodiments of the invention.

### First Embodiment

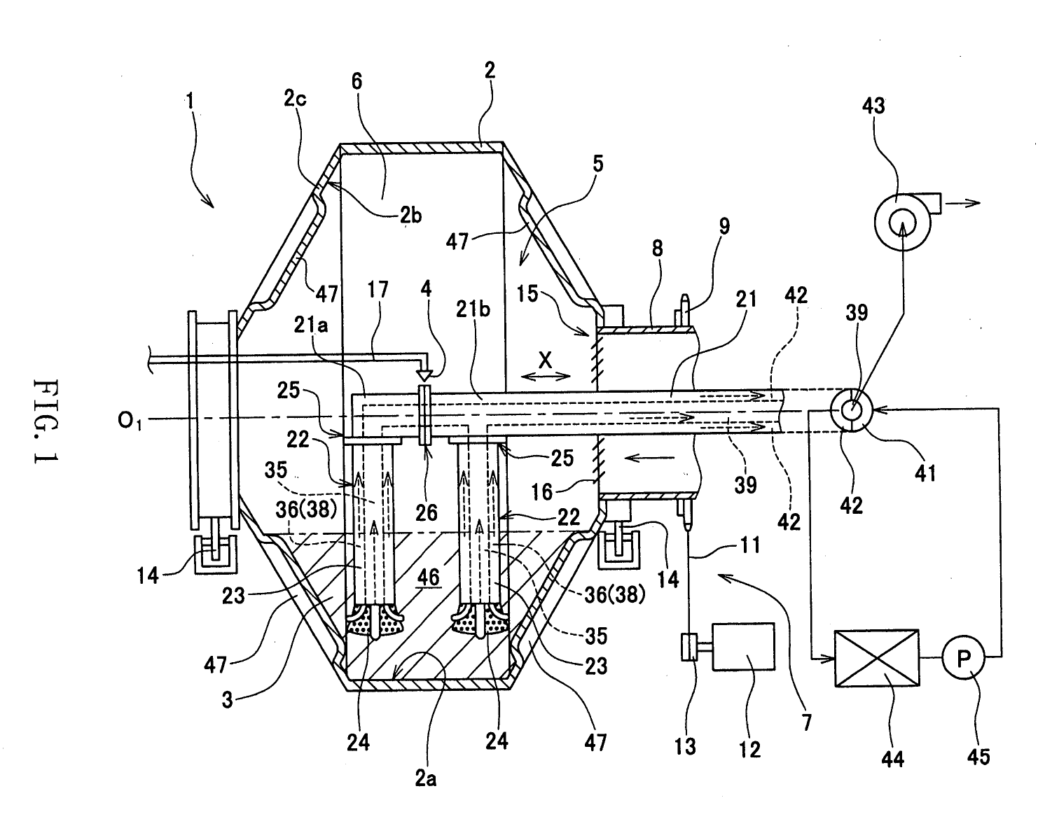

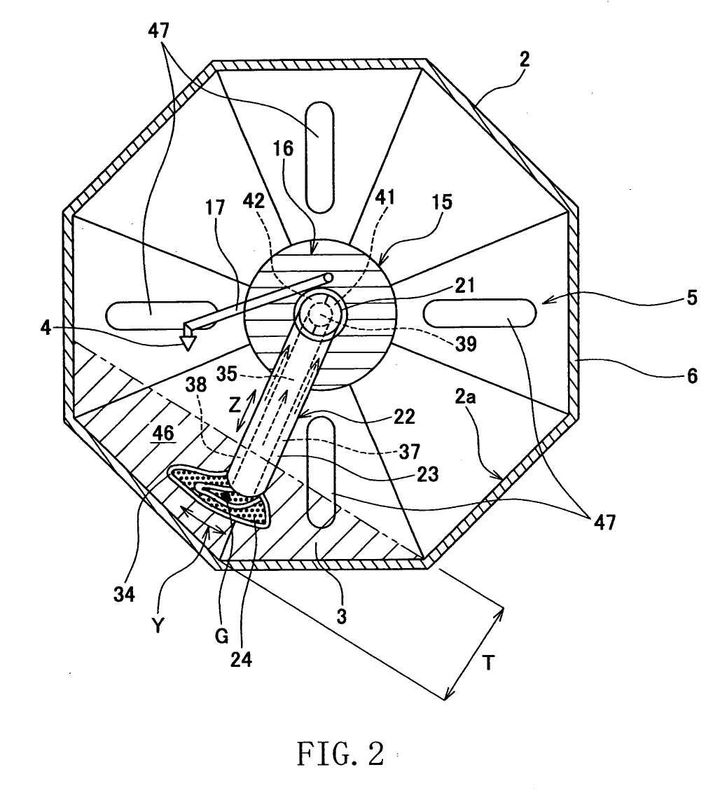

FIG. 1 is a schematic cross sectional view of the first embodiment of the present invention, which is a granulation/coating apparatus (powder and particle processing apparatus), illustrating the configuration thereof and FIG. 2 is a schematic cross sectional view of granulation/coating apparatus of FIG. 1 as viewed from the front side thereof in the direction of the axis of rotation of the rotary drum thereof (from the left side of FIG. 1). Like conventional granulation/coating apparatus, the granulation/coating apparatus of FIG. 1 is adapted to contain tablets (an object of processing) 3 which is a kind of powders and particles in a rotary drum 2 thereof and drive the drum 2 to rotate. In the drum 2, the tablets 3 roll as the drum 2 is driven to rotate and coating liquid is sprayed onto the rolling tablets 3 by using a spray gun 4. Air for drying is fed into the drum 2 simultaneously or alternately with coating liquid. Thus, the coating liquid adhering to the surface of the tablets 3 is dried and coating layers are formed on the surfaces of the powders and particles.

As shown in FIG. 1, the drum 2 is arranged at a central part of the granulation/coating apparatus 1. The drum 2 can be driven to rotate around a substantially horizontal axial line O₁ of rotation. A processing chamber 5 is formed in the inside of the drum 2 and adapted to receive the object of processing, which may be the tablets 3, pieces of chewing gums or pieces chocolate, put into it. The lateral wall 6 is formed by flat plates having no hole at all. As shown in FIG. 2, the wall 6 shows a polygonal (octagonal in FIG. 2) cross sectional view. The granulation/coating apparatus 1 has a jacketless structure of having no ventilation jacket arranged around the outer periphery of the drum 2.

A drum rotation mechanism 7 is arranged at the rear side (the right side in FIG. 1) of the drum 2. A cylindrical shaft 8 is fitted to the drum 2 at the rear side of the latter and a sprocket 9 is fitted to the right end in FIG. 1 of the shaft 8. The sprocket 9 is connected to another sprocket 13 arranged at the side of the motor 12 by way of a chain 11. Thus, as the motor 12 rotates, the drum 2 is driven to rotate around the axial line O₁ of rotation by the chain 11. The drum 2 is rotatably supported by rollers 14 arranged respectively at the front and rear sides of the drum. The drive mechanism of the drum 2 is not limited to the above-described one. Alternatively, for example, the drum 2 may be driven to rotate by a motor directly or by way of a chain or a timing belt.

The processing chamber 5 has a rear side aperture section 15, which is provided with a louver 16. Air is supplied to the shaft 8 from the outside of the drum 2 by means of a blowing means (not shown). The air supplied to the shaft 8 is adjusted by the louver 16 in terms of blowing rate and blowing direction and fed into the drum 2. A spray gun unit 17 that is equipped with the spray gun 4 is inserted into the drum 2 from the front side of the drum. The spray gun unit 17 is inserted from the outside of the drum 2 along the axial direction (extension of the axial line O₁ of rotation). Coating liquid or binding liquid is supplied to the unit 17 by way of a liquid pump (not shown). The coating liquid or some other liquid supplied to the unit 17 is then sprayed onto the tablets 3 from the spray gun 4 arranged in the drum 2.

Additionally, a clump (baffle support member) 21 is inserted into the drum 2 along the axial direction from the outside of the latter at the rear side thereof. Two baffle devices 22 that are adapted to be put into the layer of powders and particles 46 are fitted to the clamp 21. The clamp 21 and the baffle devices 22 are made of stainless steel. As shown in FIG. 2, the baffle devices 22 are made to show a boot-like profile as a whole. Each of the baffle devices 22 comprises an arm 23 rigidly secured to the clamp 21 and a baffle main body (main body section) 24 fitted to the front end of the arm 23. The arm 23 is removably fitted to the clamp 21 at a connecting section 25. Additionally, the clamp 21 has a front end section 21a and a clamp main body 21b and the front end section 21a is also removably fitted to the clamp main body 21b at a connecting section 26.

Thus, when arranging the baffle devices 22 in the drum 2 of the granulation/coating apparatus 1 of FIG. 1, firstly the clamp 21 is inserted into the drum 2. Substantially, the baffle devices 22 are brought into the drum 2 from the front side (the left end side in FIG. 1). Then, the baffle devices 22 are anchored to the clamp 21 at the respective connecting sections 25 typically by means of one-touch bands, although the technique of anchoring the baffle devices to the clamp 21 is not limited to the use of one-touch bands and the baffle devices 22 may be anchored to the clamp 21 in any other appropriate anchoring mode so long as such a mode provides a reliable sealing effect. For example, the baffle devices 22 may be anchored to the clamp 21 by means of bolts that are driven into the respective baffle devices 22 and the clamp 21 by way of appropriate gaskets. Thus, the baffle devices 22, the louver 16 and the spray gun unit 17 can easily be fitted to the drum 2 of the granulation/coating apparatus 1 from the front side and the rear side thereof.

Auxiliary baffles 47 are arranged on the inclined inner wall 2b of the drum 2 in addition to the baffle devices 22. As shown in FIGS. 1 and 2, an auxiliary baffle 47 is arranged on every other sector of the inner wall 2b so as to extend in a radial direction on the conical section 2c of the drum 2. The auxiliary baffles 47 are formed to bend the conical section 2c into the drum as they are integral with the drum 2. The auxiliary baffles 47 may be omitted so that only the baffle devices 22 are used for mixing/stirring the object of processing.

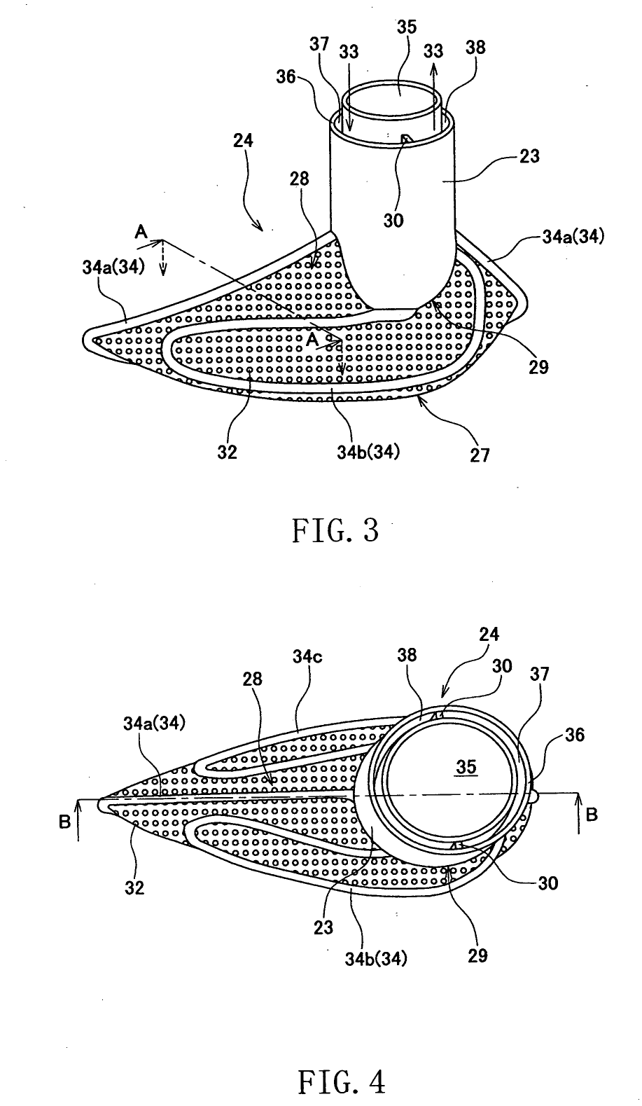

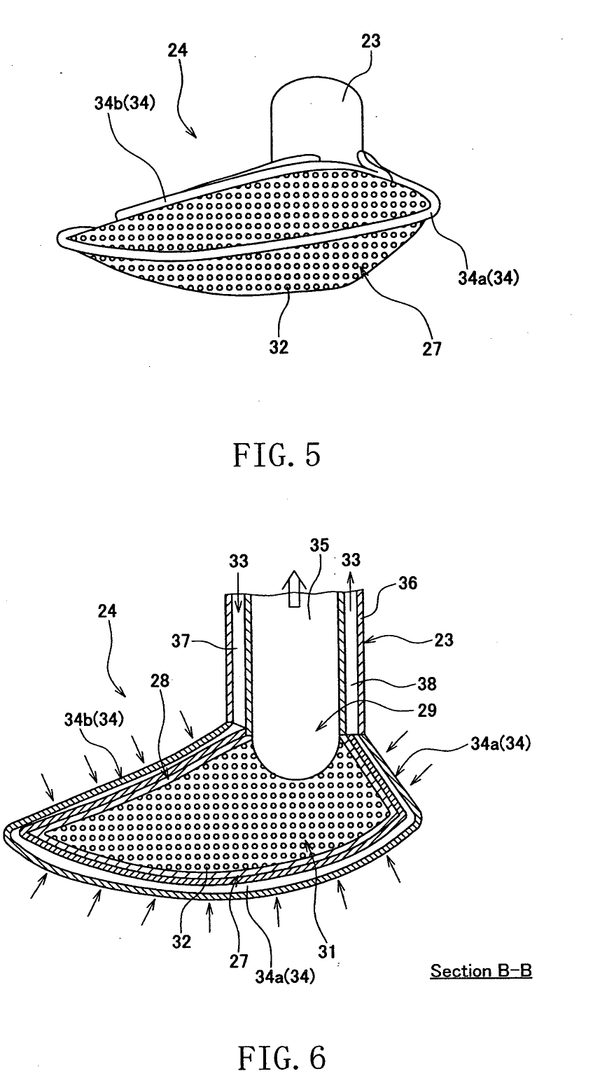

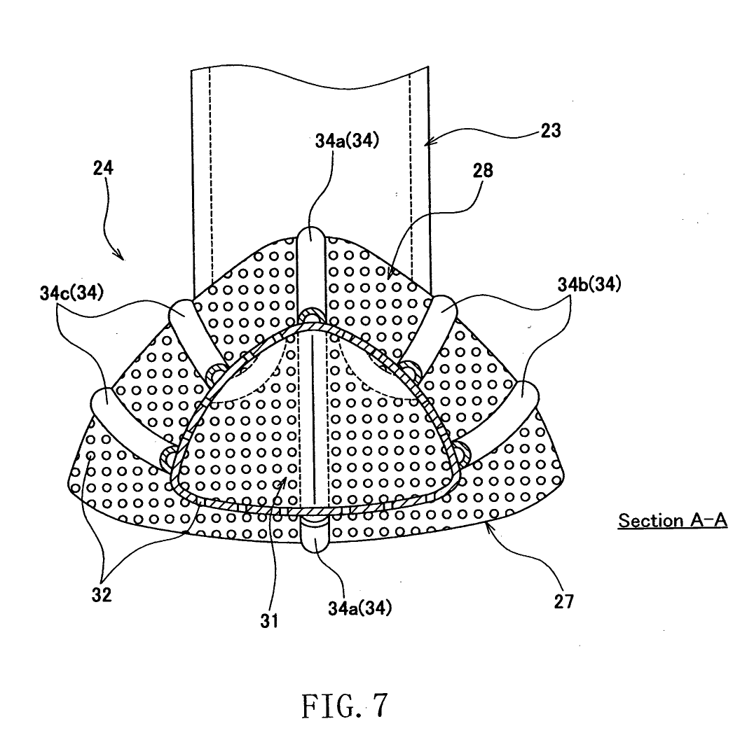

FIG. 3 is a schematic perspective view of the baffle main body 24 of one of the baffle devices of the apparatus of FIG. 1, as viewed from a lateral side thereof. FIG. 4 is a schematic perspective view of the baffle main body 24 of the apparatus of FIG. 1, as viewed from above. FIG. 5 is a schematic perspective view of the baffle main body 24 of the apparatus of FIG. 1, as viewed from below. FIG. 6 is a schematic cross sectional view of the baffle main body 24 taken along line B-B in FIG. 4. FIG. 7 is a schematic cross sectional view of the baffle main body taken along line A-A in FIG. 3. As seen from FIGS. 3 through 7, of each of the baffle devices, the baffle main body 24 is hollow and adapted to be inserted into the layer of powders and particles during a granulation/coating process as shown in FIG. 2. The baffle main body 24 is also made to show a shoe-like profile and includes a bottom surface section 27, a hollow upper section 28 arranged on the bottom surface section 27 and an aperture section 29 formed at the top of the upper section 28.

The bottom surface section 27 is arranged vis-à-vis the trunk section inner wall 2a of the drum 2 and, as shown in FIG. 7, has an outwardly curved profile (protruding toward the inner wall 2a). As show in FIG. 2, the upper section 28 is made longer at the front side in the sense of rotation of the drum 2 and tapered toward the front end. The upper section 28 is arranged in the drum 2 in such a way that the tapered front end part thereof faces the flow of the tablets 3.

The upper section 28 is made shorter at the rear side in the sense of rotation of the drum 2. With this arrangement, when the baffle main body 24 is put into the layer of powders and particles, turbulences can hardly take place at the rear side of the baffle main body 24 in the flow of the tablets 3. The upper section 28 shows a bulged profile in cross section and is expanded outwardly to a certain extent as shown in FIG. 7. With this profile of the upper section 28, the tablets 3 ride on the upper section 28 from the front end thereof and smoothly flows down toward the lateral sides thereof. The aperture section 29 is arranged at the top of the upper section 28 and located relatively at the rear side in the sense of rotation of the drum 2. The front end of the corresponding arm 23 is rigidly fitted to the aperture 29 by welding.

The baffle main body 24 is formed by punching a plate. The baffle main body 24 is provided with a large number of ventilating holes 32 through which the internal space 31 of the baffle main body 24 communicate with the outside (in the processing chamber 5). Both the bottom surface section 27 and the upper section 28 are provided with ventilating holes 32. With this arrangement, an aperture area substantially same as that of the lateral surface ventilating holes of the drum 2 of any known jacketed granulation/coating apparatus is secured. Cooling tubes (temperature adjusting sections, temperature adjusting pipes) 34 made of stainless steel are laid on the surface of the baffle main body 24 as cooling sections. The cooling tubes are rigidly fitted to the surface of the baffle main body by welding. A total of three cooling tubes are provided. A cooling medium (temperature adjusting medium) 33 that may be cold water or cold air is made to flow through the tubes 34. No ventilating holes 32 are formed in the areas of the baffle main body where the tubes 34 are laid.

One of the cooling tubes 34, or cooling tube 34a, extends from the front side of the arm 23 to the front end section of the upper section 28 by way of the central ridge part hereof and then turns round to the bottom surface section 27 at the front end of the upper section. After extending toward the rear ward of the bottom surface section 27, the tube 34a gets to the rear side of the arm 23. On the other hand, the remaining tubes 34, or cooling tubes 34b, 34c, extend forward from the respective lateral sides of the arm 23 along the breast of upper part 28. Then, they make a U-turn near the front end of the upper part 28 and return to the respective lateral lower edges to get to the rear side of the arm 23. A cooling medium 33 is supplied to the tubes 34 from the front side and the lateral sides of the arm 23. The cooling medium 33 in the tubes 34 flow toward the rear side of the arm 23, while cooling the body 24.

The arm 23 has a dual pipe structure as shown in FIGS. 3 and 6. A ventilating pipe 35 that communicates with the baffle internal space 31 is arranged at the inner side while a cooling medium supply/discharge pipe (temperature adjusting medium supply/discharge pipe) 36 that communicates with the tubes 34 is arranged at the outer side in the arm 23. The cooling medium supply/discharge pipe 36 is peripherally divided into two chambers by a partition wall 30 to form a cooling medium supply chamber (temperature adjusting medium supply chamber) 37 (front side) and a cooling medium discharge chamber (temperature adjusting medium discharge chamber) 38 (rear side). The cooling medium supply chamber 37 supplies the cooling medium 33 to the tubes 34, whereas the cooling medium discharge chamber 38 discharges the cooling medium 33 from the tubes 34. Thus, the arm 23 has a three-chamber structure that includes the ventilating pipe 35, the cooling medium supply chamber 37 and the cooling medium discharge chamber 38. While the chamber 37 and the chamber 38 show the same cross sectional area, the chamber 37 may be made to show a smaller cross sectional area in order to raise the flow rate because the chamber 37 is located above the layer 46 and hence can easily be heated.

Like the arm 23, the clamp 21 has a three-chamber structure. A ventilating pipe 39 is arranged at the center of the clamp 21 and a cooling medium supply chamber (temperature adjusting medium supply chamber) 41 and a cooling medium discharge chamber (temperature adjusting medium discharge chamber) 42 are arranged outside the ventilating pipe 39. The pipes 35, 39, the chambers 37, 41 and the chambers 38, 42 are airtightly connected typically by means of O-rings at the connecting sections 25, 26 for the clamp 21 and the arm 23. The clamp 21 extends to the outside of the drum 2 and is driven to reciprocate in the axial direction by a drive means (not shown). The drive means and the clamp 21 are movably connected to each other typically by means of a bellows-like member that is made of stainless steel. The ventilating pipe 39 is connected to an exhaust blower 43 arranged outside the drum 2. As the exhaust blower 43 is driven to operate, air is discharged from the inside of the chamber 5 to the outside of the drum 2 by way of the internal space 31 and the ventilating holes 32.

The cooling medium discharge chamber 42 is connected to a heat exchanger 44 arranged outside the drum 2. A cooling medium pump 45 is arranged downstream relative to the heat exchanger 44. The cooling medium pump 45 is connected to the cooling medium supply chamber 41. Thus, the cooling medium 33 circulates through the cooling medium pump 45 the chambers 41, 37→the tubes 34→the chambers 38, 42→the heat exchanger 44→cooling medium pump 45. The cooling medium 33 that passes through the tubes 34 to become heated as a result of cooling the baffle main body 24 is sent to the heat exchanger 44 by way of the chambers 38, 42. The cooling medium 33 is then cooled by the heat exchanger 44 and fed to the tubes 34 by the pump 45 by way of the chambers 41, 37.

Now, the coating process of the granulation/coating apparatus 1 will be described below. Firstly, tablets are put into the chamber 5 from the front side of the drum 2 as core particles to be subjected to a coating process. When the tablets 3 are put into the chamber 5 by a predetermined amount, the motor 12 is operated to drive the drum 2 to rotate. As a result, the tablets 3 are lifted in the drum 2 and flows down, while rolling. Coating liquid is sprayed onto the tablets 3 in the chamber 5 from the spray gun 4, while the drum 2 is being driven to rotate. The coating liquid contains a coating substance, a binding agent and a solvent and is sprayed from the spray gun 4 under predetermined pressure. Cold air and/or cold water is blown to the outside of the drum 2 in order to cool the drum 2 itself.

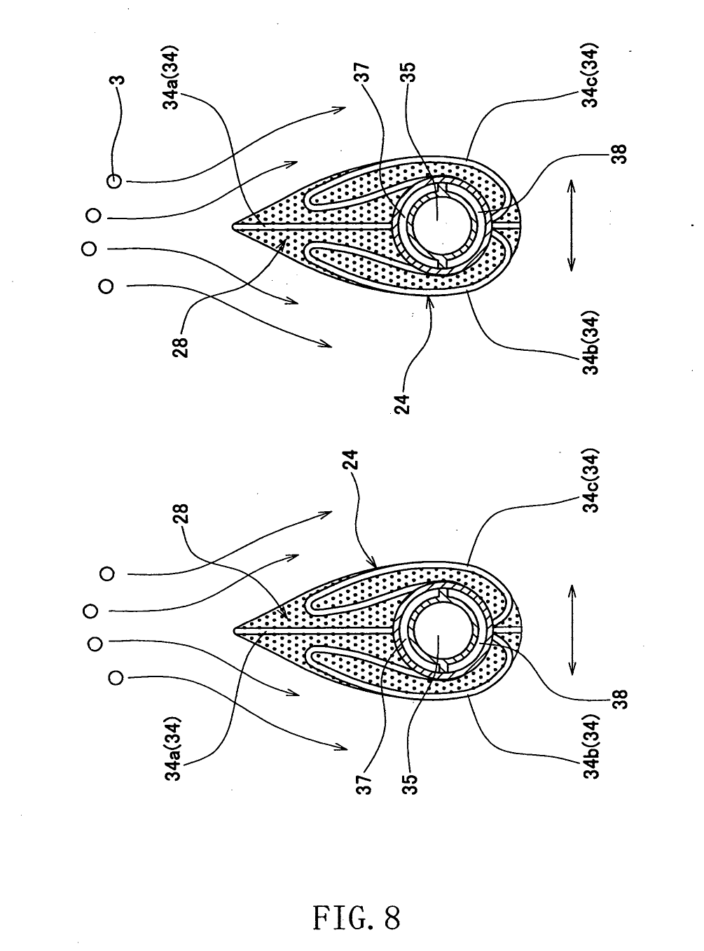

When a coating process is conducted in this way, the granulation/coating apparatus 1 is required to have the above-described three functions of mixing/stirring, ventilation and temperature adjustment in order to efficiently manufacture good products. For this purpose, the baffle devices 22 are arranged in the drum 2 of the apparatus 1 and the tablets 3 are mixed and stirred by inserting the baffle main bodies 24 into the layer 46. FIG. 8 is a schematic illustration of the effect of the baffle main bodies 24 in the layer 46. As shown in FIG. 8, the flow of the tablets 3 is obstructed by the baffle main bodies 24 and branched to the lateral sides. Additionally, the baffle devices 22 drive to move the bodies 24 back and forth (in the directions of X in FIG. 1) or swing in the layer 46. As a result, the flow of the tablets 3 is stirred in a complex manner to accelerate the mixing/stirring operation and the tablets 3 are prevented from adhering to the baffle main bodies 24. The baffle devices 22 may be so arranged as to be movable in the sense of rotation of the drum 2 (in the directions of Y in FIG. 2) or in radial directions of the drum 2 (in the directions of Z in FIG. 2). The mixing/stirring operation can be conducted efficiently with any of such moves.

From the viewpoint of efficiently conducting the mixing/stirring operation, the baffle main bodies 24 are preferably so arranged as to break the lingering zone of powders and particles that may be formed in the layer 46. For this purpose, in the apparatus 1, the baffle main bodies 24 are arranged at or near the center of gravity G of the layer 46 that shows a contour of a notched circle as seen from the shaded part in FIG. 1. As a result of an experiment, the inventors of the present invention found that the lingering zone of powders and particles substantially agrees with the center of gravity G of the layer 46. Therefore, the mixing/stirring operation can be conducted efficiently when the baffle main bodies 24 are arranged there. When it is difficult to locate the center of gravity G, the bodies 24 may be arranged at respective-positions of about 3/10 of the height of the layer 46 from the surface thereof from the viewpoint of simplicity.

In each of the baffle devices 22, air is drawn and exhausted from the body 24 inserted into the layer 46. Air is supplied into the chamber 5 from the rear side aperture section 15 of the drum 2 by way of the louver 16. Then, the air is made to pass through the layer 46, drawn out from the ventilating holes 32 of the baffle device 22 and exhausted to the outside of the drum 2 by way of the ventilating pipes 35, 39. The surface of the tablets 3 are dried by the air flow and the coating liquid is solidified to produce coating layers on the surfaces. Coating liquid is generally sprayed toward the forward side (top side) in the sense of rotation of the layer 46. The tablets 3 to which coating liquid is made to adhere then flows downward from the layer 46 as the drum 2 rotates. At this time, the tablets 3 are dried by the air that is supplied into the chamber 5, made to pass through the layer 46 and exhausted from the baffle main body 24.

When the height of the layer 46 fluctuates to a large extent during the process as in the case of a sugar coating process if the position of height of insertion of the body 24 is low, the top surface of the body 24 can become exposed from the layer 46 during the process. In such a case, air can be exhausted through the exposed ventilating holes 32 from the inside of the chamber 5. Then, it will be no longer possible to exhaust air from the inside of the layer 46. From this point of view, one of the measures shown below or a combination of any of them may be taken for a sugar coating process or the like.

First, the holes 32 located in an upper part of the upper section 28 are removed to prevent any of the existing holes 32 from being exposed to the outside of the layer 46. However, when this measure is taken, the number of holes 32 and the area of the openings thereof need to be considered in order to secure the effective total area of exhaustion.

Second, the baffle main body 24 is arranged near the inner wall 2a of the drum 2 so as to prevent the body 24 from becoming exposed if the height of the layer 46 is decreased. However, when this measure is taken, the relationship with the above-described lingering zone needs to be considered because the mixing/stirring effect can be degraded. While the body 24 can be arranged closer to the inner wall 2a when the bottom surface section 27 is made flat, the number of holes 32 will then inevitably be reduced. Additionally, care should be taken about that, if the gap between the bottom surface section 27 and the inner wall 2a is made too small, the gap can be clogged by the tablets 3 to reduce the turnout.

Third, the-baffle main body 24 is arranged so as to be movable in a radial direction so that the position of the body 24 may be shifted as the process progresses. This measure is most reliable and the move of the body 24 can be automatically controlled. However, then, the overall configuration of the apparatus will become complex so much.

Meanwhile, as air is exhausted from the chamber 5, the temperature of the baffle main body 24 itself rises. Then, coating liquid and the tablets 3 (to be collectively referred to as coating liquid etc. hereinafter for the purpose of simplicity) can adhere to the body 24 if no preventive measure is taken. In other words, the body 24 needs to be cooled. In this apparatus 1, cold water is made to flow through the tubes 34 to cool the body 24 and prevent coating liquid etc. from adhering to it. More specifically, the body 24 is cooled to a temperature level lower than 30° C., preferably lower than 25° C., by supplying cold water to the tubes 34. As a result of an experiment, the inventors of the present invention found that the rate at which coating liquid etc. adheres to the body 24 rapidly rises when the temperature of the body 24 rises above 30° C. On the basis of this finding, the body 24 of the apparatus is cooled to lower than 30° C.

Coating liquid is sprayed, while mixing/stirring the layer of powders and particles, and dried by drying air to form coating layers on the surfaces of powders and particles. The process is terminated when a predetermined amount of coating liquid is sprayed to produce desired coating layers on the powders and particles of the tablets 3. Since the baffle main body 24 is cooled by the cooling tubes 34, coating liquid etc., hardly adheres to it. While coating liquid etc., can adhere to the clamp 21 and the arm 23 when the temperature rises, the cooling medium 33 is made to flow to and cool the clamp 21 and the arm 23 so that, in fact, coating liquid etc., hardly adheres to them either. Thus, defective products showing spots and/or swells that are produced when the coat layer is partly removed are minimized and the granulation/coating process is conducted efficiently.

After the end of the granulation/coating process, the apparatus is washed appropriately. Since the drum 2 of the apparatus 1 has no punched out part and shows a jacketless structure, it can easily be washed with pooled water by means of CIP washing. When water is used as the cooling medium 33, preferably the cooling medium supply chamber 41 is connected to a compressed air supply means to drain the water supply/discharge (drain) system by means of high pressure blowing for the purpose of washing the baffle device 22 because, otherwise, water can be left in the water supply/discharge (drain) system including the chambers 41, 37, the tubes 34 and the chambers 38, 42.

Thus, in the above-described granulation/coating apparatus according to the present invention, the tablets 3 are mixed and stirred by means of the baffle devices 22 and the baffle devices 22 are exhausted from the body 24 and cooled. Therefore, the baffle devices 22 can realize all the three functions of mixing/stirring, ventilation and cooling (temperature adjustment). If compared with known granulation/coating apparatus equipped with devices adapted to operate only for one or two of the functions, the configuration of the entire apparatus can be simplified to a large extent. Thus, the number of parts is reduced and the equipment is simplified to reduce the cost of the apparatus and allow the apparatus to be downsized. Additionally, the apparatus can be washed efficiently in a simple manner.

### Second Embodiment

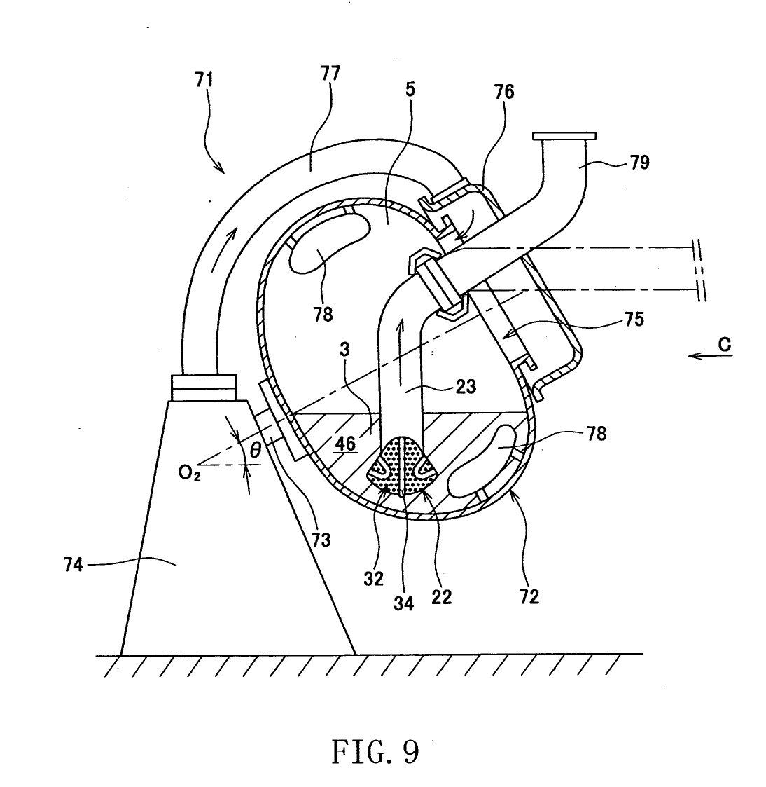

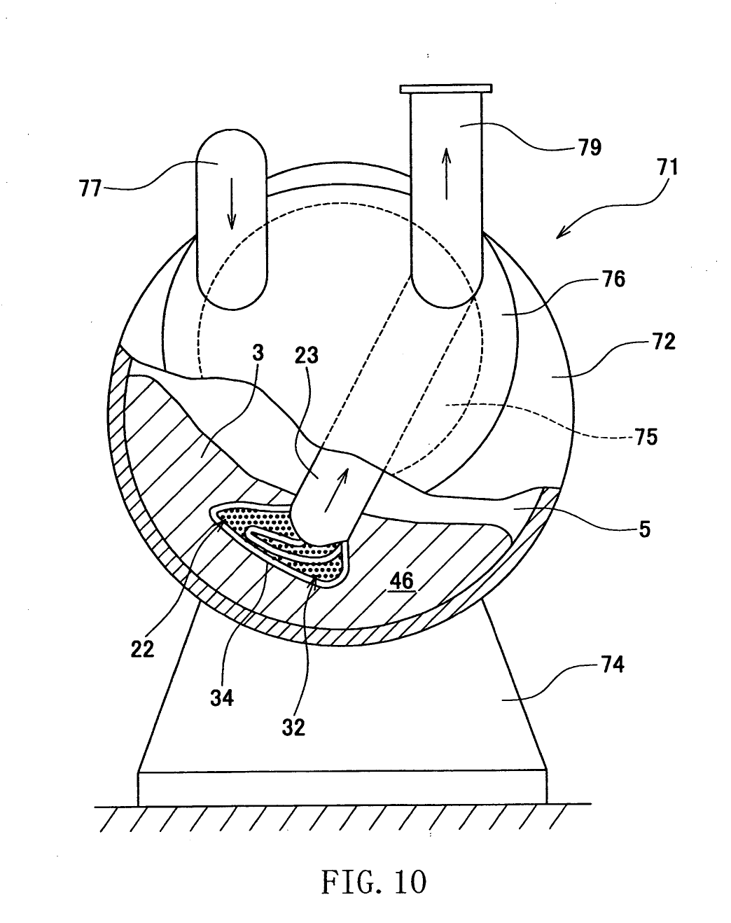

FIG. 9 is a schematic cross sectional view of the second embodiment of the present invention, which is a granulation/coating apparatus 71, illustrating the configuration thereof. FIG. 10 is a schematic partially cut out cross sectional front view of granulation/coating apparatus 71 of FIG. 9 as viewed in the direction of the arrow C in FIG. 9. The members and parts of the second embodiment same as those of the first embodiment are denoted respectively by the same reference symbols and will not be described here any further.

The granulation/coating apparatus 71 of FIGS. 9 and 10 is a conventional coating pan without a ventilating mechanism. The axial line O₂ of rotation of a rotary drum 72 is inclined by angle θ relative to the plane of installation P. The rotary drum 72 is made to show an oval (ellipsoidal) profile and equipped with a rotary shaft 73 at the rear lower side (lower left side in FIG. 9). The rotary shaft 73 extends into the base 74 and connected to a drive means (not shown) such as a motor contained in the base 74. As the shaft 73 is driven to rotate by the drive means, the drum 72 rotates around the axial line )₂ of rotation.

An aperture section 75 is arranged at the front upper side of the drum 72 (upper right side in FIG. 9). A bottomed short cylindrical closure body 76 is fitted to the aperture section 75 from the outside. An air supply duct 77 is fitted to the closure body 76. The air supply duct 77 is connected to an air supply means (not shown) arranged outside the apparatus. Hot air or cool air is supplied to the closure body 76 by way of the duct 77. The air supplied from the duct 77 is then fed from the inside of the closure body 76 into the processing chamber 5 in the drum 72 by way of the aperture section 75. A baffle 78 is fitted to the inner wall of the drum 72.

Like the granulation/coating apparatus 1 of the first embodiment, a baffle device 22 is arranged in the drum 72. The baffle device 22 is fitted to an exhaust duct 79 that is rigidly secured to the closure body 76. Thus, the exhaust duct 79 operates as baffle support member. The arm 23 of the baffle device 22 and the duct 79 have a dual pipe structure as in the case of the first embodiment so that they operate both for exhaustion and the supply/discharge of the temperature adjusting medium by means of one device. The baffle device 22 is fitted to the inside of the drum 72 by way of the aperture section 75 at the front side of the apparatus. Thus, while the baffle devices of the apparatus 1 of the first embodiment are mounted from the rear side of the apparatus, a baffle device 22 according to the present invention can also be mounted from the front side of the apparatus. Additionally, a baffle device 22 according to the present invention can be used in a coating pan apparatus where the axial line of rotation of the rotary drum is inclined.

The exhaust duct 79 is connected to an exhaust means (not shown) and, if necessary, also to a cooling unit. To make the baffle device 22 movable back and forth (left and right in FIG. 9), the duct 79 is arranged substantially horizontally as indicated by dotted chain lines in FIG. 9. More specifically, the duct 79 is mounted loosely in the closure body 76 so as to be movable left and right. Alternatively, the baffle device 22 may be arranged so as to be movable in the sense of rotation and/or in radial directions of the drum 72 as in the case of the apparatus 1 of the first embodiment.

In a coating process, the tablets 3 are put into the drum 72 of the granulation/coating apparatus 71 by way of the aperture section 75 and the drum 72 is driven to rotate. In the drum 72, the tablets 3 roll as the drum 72 is driven to rotate and coating liquid is sprayed onto the rolling tablets 3 by means of a spray gun (not shown). Air for drying is fed into the drum 72 through the air supply duct 77 simultaneously or alternately with coating liquid. Thus, the coating liquid adhering to the surface of the tablets 3 are dried and coating layers are formed on the surfaces of the powders and particles. Cold air and/or cold water may be blown to the outside of the drum 72 in order to cool the drum 72 itself.

In the processing chamber 5, the baffle main body 24 of the device 22 is driven into the layer 46 of the tablets 3 to mix/stir the tablets 3. Additionally, in the chamber 5, air is drawn and exhausted from the body 24 driven into the layer 46. More specifically, the air supplied into the chamber 5 from the aperture section 75 of the drum 72 passes through the layer 46 and drawn from the ventilating holes 32 of the device 22 and exhausted to the outside of the drum 72 by way of the duct 79. Due to the air flow, the surface of the tablets 3 is dried and the coating liquid on the surface is solidified to form a coating layer.

Meanwhile, the baffle main body 24 is cooled by cold water flowing through the cooling tubes 34. As a result, coating liquid etc. is prevented from adhering to the body 24. The exhaust duct 79 and the arm 23 are also cooled so that coating liquid etc. is also prevented from adhering to them. Thus, defective products showing spots and/or swells that are produced when the coat layer is partly removed are minimized and the granulation/coating process is conducted efficiently. Therefore, the baffle devices 22 can realize all the three functions of mixing/stirring, ventilation and cooling (temperature adjustment) in the granulation/coating apparatus 71 of this embodiment. The present invention can find applications in known coating pans having no ventilation mechanism.

The present invention is by no means limited to the above-described embodiments, which may be modified and altered in various different ways without departing from the spirit and scope of the invention.

For example, while cooling tubes 34 are laid on the surface of the baffle main body 24 in the above-described embodiments, the mode of arrangement of the cooling section (temperature adjusting section) of the body 24 is not limited thereto. For example, cooling tubes 34 may alternatively be laid on the inner surface side of the baffle main body 24. Then, the tubes 34 do not project from the surface of the body 24 to allow the tablets 3 to flow more smoothly.

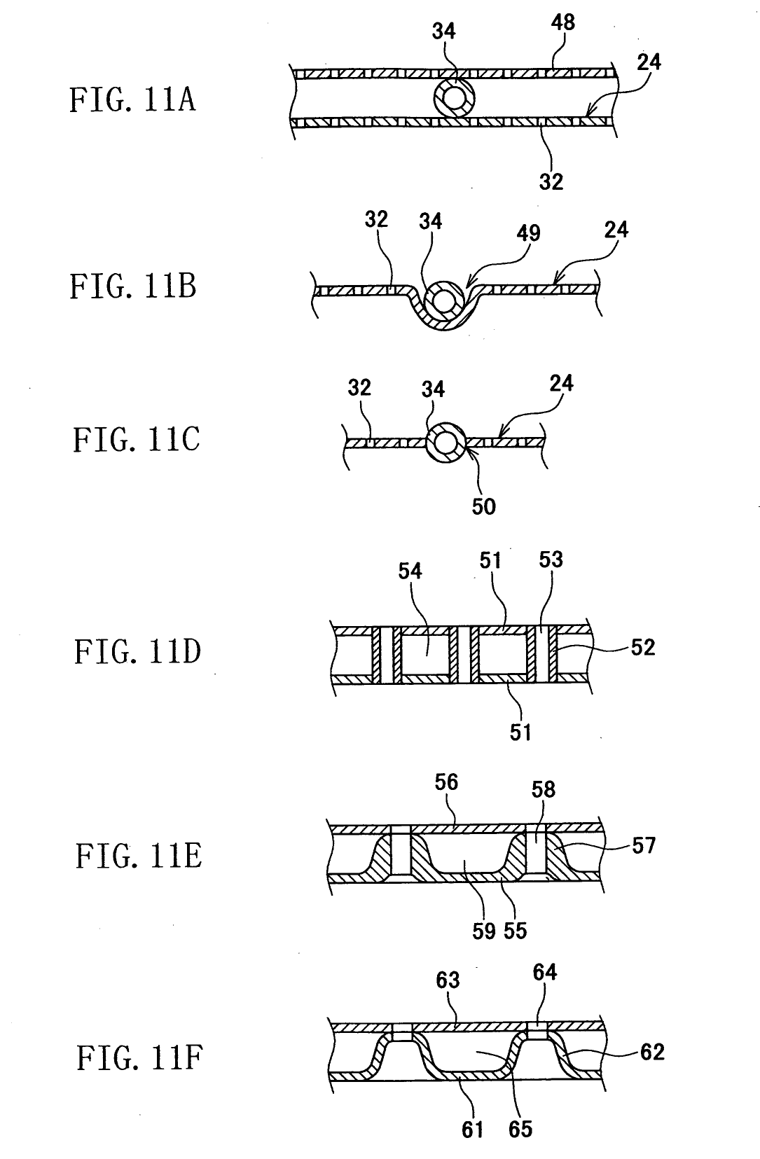

The arrangement and configuration of the cooling tubes 34 and the configuration of the baffle main body 24 are not limited to those described above by referring to the embodiments. FIGS. 11A through 11F are schematic illustrations of possible modified baffle main bodies, illustrating the structures thereof. Referring to FIG. 11A, a cover 48 formed by punching a steel plate is put to the outside of the baffle main body 24 and cooling tubes 34 are arranged between the body 24 and the cover 48 to produce a sandwich structure. Referring to FIG. 11B, grooves 49 are formed on the surface of the baffle main body 24 to receive respective cooling tubes 34 there. With this arrangement, the tubes 34 do not project from the surface of the body 24. Referring to FIG. 11C, cooling tubes 34 may be arranged to interrupt the surface of the baffle main body 24. More specifically, the tubes 34 are rigidly secured to the respective slits 50 formed in the body 24 typically by welding.

FIG. 11D illustrates still another possible arrangement. Referring to FIG. 11D, two steel plates 51 are arranged one above another with a gap interposed between them to separate them in order to provide the baffle main body 24 with a double-layer structure. Then, rods 52 are buried in the body 24 so as to perpendicularly run through the two steel plates 51. A vertical through hole is bored through each of the rods 52. The rods 52 may be replaced by hollow pipes. Then, the space 54 between the two steel plates 51 operates as flow path for the cooling medium 33, while the through holes 53 operate as ventilating holes 32.

Referring now to FIG. 11E, a dimpled steel plate 55 and a flat steel plate 56 are bonded to each other by welding. Vertical through holes 58 are bored through the dimple sections 57 of the plate 55. The space 59 between the dimpled steel plate 55 and the steel plate 56 operates as flow path for the cooling medium 33, while the through holes 58 operate as ventilating holes 32. Referring finally to FIG. 11F, a flat steel plate 61 is contracted to produce projections 62 and a flat plate 63 is bonded thereto by welding. A vertical through hole 64 is bored through each of the projections 62. Then, the space 65 between the plates 61, 63 operates as flow path for the cooling medium 33, while the through holes 64 operate as ventilating holes 32.

While stainless steel half pipes showing a semicircular cross section as shown in FIG. 7 are used for the cooling tubes 34 in the above-described embodiments, the profile of the tubes 34 is not limited thereto. For example, more flat pipes showing a cross section of a half of an ellipse, that of a half of a spindle or that of a half of a water drop may alternatively be used. Still alternatively, pipes showing a circular cross section may be used. The outer surfaces of the cooling tubes directed to the front side may be made to show a mild slope to improve the mobility of the tablets 3.

While the baffle main body 24 shows a shoe-like profile in the above description of the embodiments, the profile is not limited to those illustrated in FIGS. 3 through 7 and may alternatively show a boat-like profile, an ellipsoidal profile, a spindle-like profile, a profile of a water droplet or some other profile. The number of baffle devices 22 is not limited to two and may alternatively be three or one, although the number of baffle devices is preferably not less than two from the viewpoint of providing a sufficient ventilating area. While the clamp 21 and the arm 23 have three-chamber dual pipe structure in the above description, they may alternatively have a triple pipe structure. Additionally, the drum 2 is not limited to a horizontal rotary drum having a horizontal axial line of rotation and may alternatively be a tilted rotary drum having an axial line O₁ of rotation that is inclined relative to the ground surface as in the case of the second embodiment.

While the above embodiments are described in terms of coating (sugar coating) of tablets, an apparatus according to the present invention is equally applicable to other coating processes such as a chocolate coating process. Generally, it is preferable that a chocolate coating process is conducted under a heated condition and hence hot water and/or hot air is supplied to the baffle devices 22 as temperature adjusting medium. Then, the cooling tubes 34 that operate as temperature adjusting sections operate as heating tubes (heating sections, temperature adjusting tubes) and the cooling medium supply/discharge pipes 36, the cooling medium supply chambers 37, 41 and the cooling medium discharge chambers 38, 42 operate as heating medium supply/discharge pipes, heating medium supply chambers and heating medium discharge chambers respectively. Additionally, hot air and/or hot water is blown to the outside of the drum 2, 72 to heat the drum 2, 72 itself.

What is claimed is:

1. A powder and particle processing apparatus comprising a rotary drum adapted to rotate around an axial line and capable of containing powders and particles in the inside and a baffle device arranged in the rotary drum so as to be inserted into the powders and particles in the rotary drum, the baffle device including:
a hollow main body section to be inserted into the powders and particles;
ventilating holes formed in the main body section to keep the inside and the outside of the main body section in communication with the each other;
a ventilating pipe fitted to the main body section and held in communication with the internal space of the main body section;
a temperature adjusting section arranged at the main body section and adapted to allow a temperature adjusting medium to flow in the inside thereof; and
a temperature adjusting medium supply/discharge pipe fitted at the main body section and held in communication with the temperature adjusting section.

2. The apparatus according to claim 1, wherein
the temperature adjusting medium is a cooling medium using water or air and the temperature adjusting section is a cooling section for cooling the main body section.

3. The apparatus according to claim 1, wherein
the temperature adjusting medium is a heating medium using water or air and the temperature adjusting section is a heating section for heating the main body section.

4. The apparatus according to claim 1, wherein
the main body section includes a bottom surface section arranged vis-à-vis the inner wall of the rotary drum, a hollow upper section formed above the bottom surface section and an aperture section formed at the upper end of the upper section and connected to the ventilating pipe.

5. The apparatus according to claim 4, wherein
the main body section is made to show a shoe-like profile.

6. The apparatus according to claim 1, wherein
the temperature adjusting medium supply/discharge pipe includes a temperature adjusting medium supply chamber for supplying a temperature adjusting medium to the temperature adjusting section and a temperature adjusting medium discharge chamber for discharging the temperature adjusting medium from the temperature adjusting section, and the temperature adjusting medium supply chamber and the temperature adjusting medium discharge chamber are arranged outside the ventilating pipe.

7. The apparatus according to claim 1, further comprising:
a baffle supporting member inserted into the rotary drum from the outside of the rotary drum and connected to the ventilating pipe and the temperature adjusting medium supply/discharge pipe.

8. The apparatus according to claim 7, wherein
the temperature adjusting medium supply/discharge pipe includes a temperature adjusting medium supply chamber for supplying a temperature adjusting medium to the temperature adjusting section and a temperature adjusting medium discharge chamber for discharging the temperature adjusting medium from the temperature adjusting section and the baffle supporting member is a three-chamber structure having the ventilating pipe, the temperature adjusting medium supply chamber and the temperature adjusting medium discharge chamber.

9. The apparatus according to claim 1, wherein
the temperature adjusting section is a temperature adjusting pipe laid on the surface of the main body section.

10. The apparatus according to claim 1, wherein
the baffle device is made movable in a direction selected from the axial direction, the direction of rotation of the rotary drum and a radial direction of the rotary drum.

11. A baffle device to be used in a powder and particle processing apparatus having a rotary drum, the device comprising:
a hollow main body section;
ventilating holes formed in the main body section to keep the inside and the outside of the main body section in communication with the each other;
a ventilating pipe fitted to the main body section and held in communication with the internal space of the main body section;
a temperature adjusting section arranged at the main body section and adapted to allow a temperature adjusting medium to flow in the inside thereof; and
a temperature adjusting medium supply/discharge pipe fitted at the main body section and held in communication with the temperature adjusting section.

12. The device according to claim 11, wherein
the temperature adjusting medium is a cooling medium using water or air and the temperature adjusting section is a cooling section for cooling the main body section.

13. The device according to claim 11, wherein
the temperature adjusting medium is a heating medium using water or air and the temperature adjusting section is a heating section for heating the main body section.

14. The device according to claim 11, wherein
the main body section includes a bottom surface section arranged vis-à-vis the inner wall of the rotary drum, a hollow upper section formed above the bottom surface section and an aperture section formed at the upper end of the upper section and connected to the ventilating pipe.

15. The device according to claim 14, wherein
the main body section is made to show a shoe-like profile.

16. The device according to claim 11, wherein
the temperature adjusting medium supply/discharge pipe includes a temperature adjusting medium supply chamber for supplying a temperature adjusting medium to the temperature adjusting section and a temperature adjusting medium discharge chamber for discharging the temperature adjusting medium from the temperature adjusting section, and the temperature adjusting medium supply chamber and the temperature adjusting medium discharge chamber are arranged outside the ventilating pipe.

17. The device according to claim 11, wherein
the temperature adjusting section is temperature adjusting pipes laid on the surface of the main body section.
